(19) United States
(12) Patent Application Publication
(10) Pub. No.: US 2013/0301262 A1
(43) Pub. Date: Nov. 14, 2013

(54) LIGHTING DEVICE AND A LUMINAIRE COMPRISING THE LIGHTING DEVICE

(71) Applicants: Wendy Li, Shanghai (CN); Xiaoyan Zhu, Shanghai (CN); Shitao Deng, Shanghai (CN)

(72) Inventors: Wendy Li, Shanghai (CN); Xiaoyan Zhu, Shanghai (CN); Shitao Deng, Shanghai (CN)

(73) Assignee: KONINKLIJKE PHILIPS ELECTRONICS N.V., Eindhoven (NL)

(21) Appl. No.: 13/980,065

(22) PCT Filed: Jan. 16, 2012
(86) PCT No.: PCT/IB2012/050197

§ 371 Date: Jul. 17, 2013

(30) Foreign Application Priority Data
Jan. 19, 2011 (CN) PCT/CN2011/070388

(51) Int. Cl. F21V 13/04; F21V 21/00; F21V 7/09

(52) U.S. Cl. CPC F21V 13/04; F21V 7/09; F21V 21/00
USPC 362/235; 362/296.01; 362/308; 362/431

(57) ABSTRACT

The invention discloses a lighting device (1) and a luminaire (3) comprising one or more lighting devices (1) mounted into a pole (2). The lighting device (1) comprises an optical module. The optical module directs the light from a light source (10) into two parts of light (L1, L2), wherein the first part of light (L1) and the second part of light (L2) are different in luminance intensity distribution. In particular, the optical module comprises a first optical element (20) directing light from a light source (10) into the first part of light (L1), and a second optical element (30) directing the light from the light source (10) into the second part of light (L2).

### FIELD OF THE INVENTION

The present invention relates to the field of illumination, especially to a lighting device and a luminaire comprising the lighting device.

### BACKGROUND OF THE INVENTION

CN201302073Y discloses a straight rod-type LED multipoint directional lighting street lamp. Two to four groups of LED directional lamps are arranged on the pole of the lamp, and each group of LED directional lamps comprises a plurality of LEDs. The radiation angle of each LED is precise and directed to illuminate one area of the road.

### SUMMARY OF THE INVENTION

The multipoint directional lighting street lamp disclosed in CN201302073Y provides light which is directed toward the road but which cannot provide sufficient vertical illumination, which causes the problem that persons on the road, such as pedestrians or cyclists, cannot be effectively detected.

The present invention is an improvement over the currently available lighting device, for example a street lamp.

In a first aspect of the invention, there is provided a lighting device comprising an optical module, and the optical module comprises: a first optical element, configured to direct light from a light source into a first part of light, and a second optical element, configured to direct the light from the light source into a second part of light, wherein the first part of light and the second part of light are different in luminance intensity distribution.

Preferably, the first optical element is configured to concentrate the first part of light on a portion of a road surface.

By concentrating part of the light from the light source on a portion of the road surface, for example the non-motorway part of the road surface, the lighting device is more energy efficient and sufficient illumination on the non-motor way part is provided such that pedestrians or cyclists can be detected by motorists and motorcyclists in an easier way. Moreover, since part of the light from the light source is concentrated on the functional task area, e.g. the non-motorway part of the road surface, the light flux consumption needs can be accurately calculated according to the standard requirements for the lamination level on the non-motorway part of the road surface. Thus, the lighting device can be designed in a more predictable and accurate way.

Further, the first optical element is configured such that the illumination of the first part of light on the road surface is homogeneous. For example, the first optical element comprises any one of the following: a specularly reflecting surface; a lens. Further, it is possible that the form of the specularly reflecting surface is a curve comprising one or more of the following: parabola; tilt parabola; flat plane; hyperbola; tilt hyperbola. Preferably, the second optical element is configured to direct the second part of light toward a space above a portion of the road surface.

Further, the second optical element is configured to diffuse the light from the light source. For example, the second optical element comprises any one of the following: a diffusely reflecting surface; a piece of glass that is frosted.

As the light from the light source is diffused by the second optical element, for example either a frosted reflector or a frosted piece of glass, soft illumination can be provided, for example, in the space between the road surface and the mounting height of the lighting device, and the surface luminance can be also reduced when the lighting device is in the field of vision of persons on the road, such as pedestrians or cyclists on the road.

Preferably, the lighting device further comprises the light source, which comprises, for example, one or more LEDs.

Since the useful life of LEDs is much longer than that of currently available fluorescent lamps, the useful life of the lighting device is extended. Further, the light source preferably comprises more than one homogeneous LED. Thus, even if some of the LEDs are out of operation, both the first part of light and the second part of light still can be generated, thereby achieving full functionality of the lighting device. This is because the first optical element and the second optical element are configured to direct the light from each LED into the first and second part of light, respectively. Thus, the lighting device is more robust.

In a second aspect of the invention, there is provided a luminaire comprising: a pole, and one or more of the above-mentioned lighting devices, as claimed in any one of claims 1 to 3, mounted into the pole.

Preferably, the one or more lighting devices are mounted at a predetermined distance from the bottom of the pole.

The predetermined distance can be selected so that no light will enter directly into the eyes of persons on the road, thereby avoiding uncomfortable glare.

Preferably, two or more lighting devices are mounted in a horizontal direction or in a vertical direction. Thus, failure of one lighting device will not affect the lighting function of the luminaire as a whole. The luminaire is more robust.

Additionally or alternatively, the two or more lighting devices are mounted so that the corresponding first part of light of at least two of the two or more lighting devices is directed in a different direction. For example, the at least two lighting devices can be mounted so that the light is directed toward different portions of the road surface.

### BRIEF DESCRIPTION OF THE DRAWINGS

Other features, purposes and advantages of the present invention will become more apparent from the following detailed description of non-limiting exemplary embodiments taken in conjunction with the accompanying drawings.

FIG. 1 illustrates the structure of a lighting device according to an embodiment of the invention;

FIG. 2 illustrates a schematic luminous intensity plot of the lighting device in FIG. 1.

FIG. 3 illustrates the structure of a lighting device according to another embodiment of the invention;

FIG. 4 illustrates a side view of a portion of a luminaire according to an embodiment of the invention; and

FIG. 5 illustrates a top view of a luminaire according to another embodiment of the invention.

Identical or similar reference signs indicate identical or similar devices (modules).

### DETAILED DESCRIPTION OF EMBODIMENTS

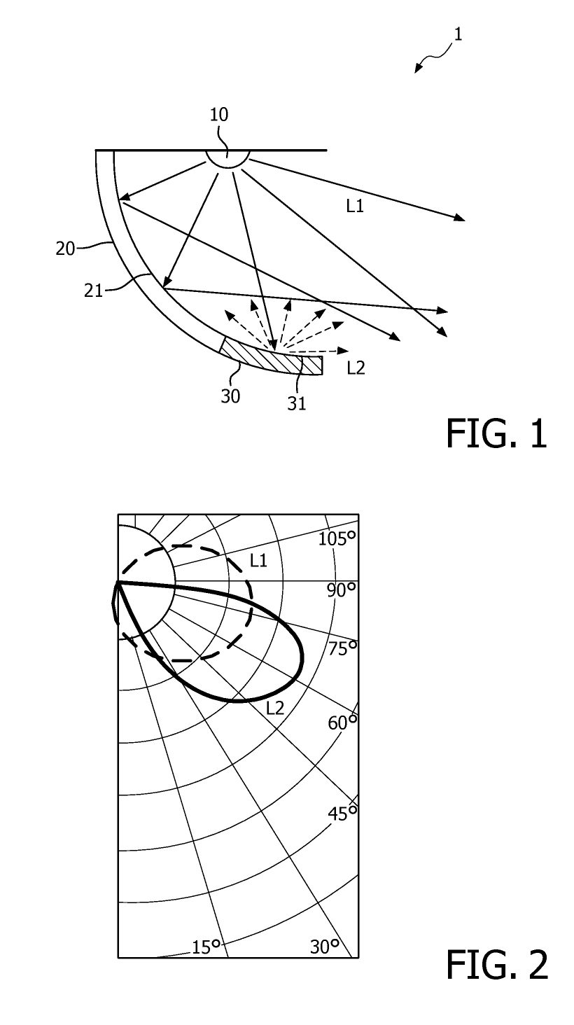

FIG. 1 illustrates a lighting device 1 according to an embodiment of the invention. The lighting device 1 comprises a light source 10, a first reflector 20 with a specularly reflecting surface 21 and a second reflector 30 with a diffusely reflecting surface 31.

Referring to FIG. 1, the reflecting surface 21 of the first reflector 20 is, for example, polished and thus reflects the incident light according to the laws of reflection, also called the mirror reflection law. In this way, the first reflector 20 directs the light from the light source 10 into a first part of light L1 as depicted by means of solid line arrows.

Further referring to FIG. 1, the reflecting surface 31 of the second reflector 30 is, for example, frosted and thus diffusely reflects the incident light. In this way, the second reflector 30 directs the light from the light source 10 into a second part of light L2 as depicted by means of dashed line arrows.

Thus, by means of the two reflectors 20 and 30, light from the same light source 10 can be directed into two parts of light L1 and L2 having a different luminous intensity.

FIG. 2 illustrates a schematic luminous intensity plot of the lighting device in FIG. 1. The luminous intensity distribution of the light reflected by the polished reflecting surface 21 of the first reflector 20 is depicted by means of solid curves in the intensity plot of FIG. 2, and the dashed curves in the same plot depict the luminous intensity distribution of the light diffused or scattered by the frosted reflecting surface 31 of the second reflector 30.

In practice, the first part of light L1 and the second part of light L2 having a different luminous intensity distribution can consequently be used for different functionalities. The two reflectors 20 and 30 as well as their relative positioning with respect to the light source 10 can be individually designed so as to produce light having a luminous intensity distribution as required by the respective functionality.

Preferably, the reflecting surface 21 of the first reflector 20 can be configured so that the first part of light L1 achieves a luminous intensity distribution that produces homogeneous illumination on a target surface. For example, when such a lighting device is integrated in a luminaire for road lighting, the first part of light L1 can be directed to a road surface and produce homogeneous illumination along the road surface. The person skilled in the art should understand that the form of the reflecting surface 21 of the first reflector 20 can be any of the following: parabola, tilt parabola, flat plane, hyperbola, tilt hyperbola and other proper curves or a complex curve composed of a combination of the aforementioned curves.

Alternatively, the first reflector 20 and the second reflector 30 can be a single reflector, wherein the major part 21 of its reflecting surface is polished to reflect the light according to the laws of reflection and the other part 31 of its reflecting surface is frosted to diffusely reflect the light.

Preferably, the light source 10 can be composed of, for example, one or more LEDs. The LEDs can be soldered on a PCB either individually or as a cluster.

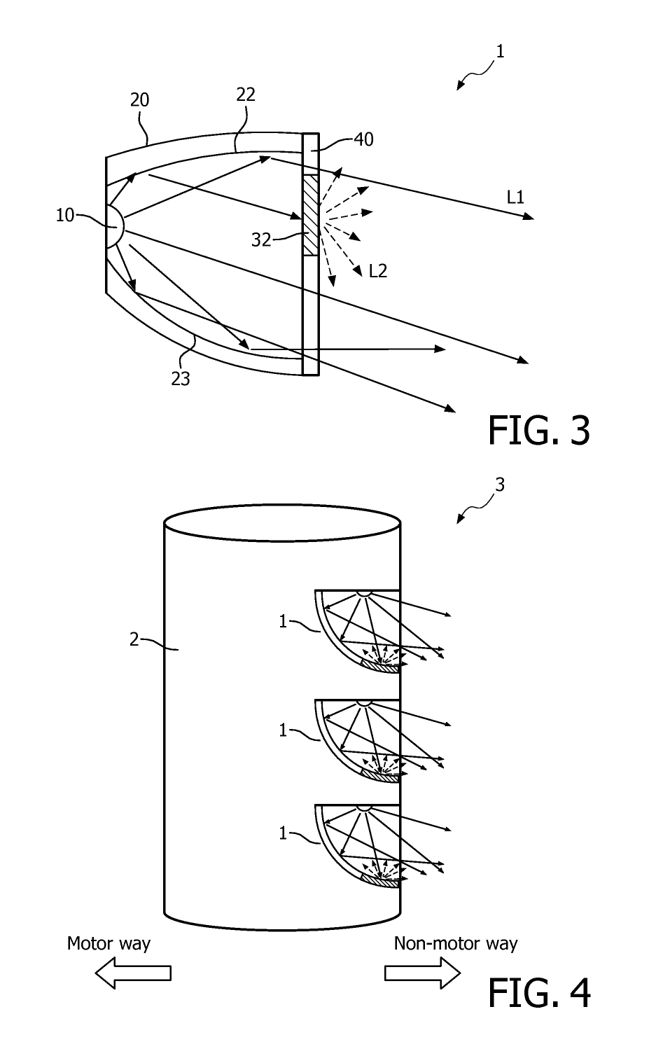

FIG. 3 illustrates the structure of a lighting device according to another embodiment of the invention. The lighting device 1 comprises a light source 10, a reflector 20 with two specularly reflecting surfaces 22 and 23 and a sealing glass 40, wherein part of the sealing glass 40 is transparent and the other part 32, as depicted by means of a pattern of diagonal downward strokes, is frosted.

Referring to FIG. 3, the reflecting surfaces 22 and 23 of the first reflector 20 are, for example, polished and thus reflect the incident light according to the laws of reflection, also called the mirror reflection law. Part of the light reflected by the first reflector 20 directly passes through the transparent part of the sealing glass 40, resulting in a first part of light L1 as depicted by means of solid line arrows. Additionally, part of the light reflected by the first reflector 20 and/or the light originating directly from the light source 10 are diffused or scattered when passing through the frosted part of the sealing glass 40, resulting in a second part of light L2 as depicted by means of dashed line arrows.

Similar to the lighting device of FIG. 1, the lighting device of FIG. 3 can achieve two parts of light L1 and L2 having a different luminous intensity, as show in FIG. 2, by means of the light source 10, the reflector 20 and the sealing glass 40. Likewise, these two parts of light can be used for different functionalities.

Preferably, either one of the reflecting surfaces 22 and 23 of the reflector 20 can be configured so that the first part of light L1 achieves a luminous intensity distribution that produces homogeneous illumination on a target surface. For example, when such a lighting device is integrated in a luminaire for road lighting, the first part of light L1 can be directed to a road surface and produce homogeneous illumination thereon.

Further, the reflector 20 can be configured to sharply cut-off the light from the light source 10 such that no light will go directly to the eyes of persons on the road. For example, the reflector 20 can be configured in such a way that the reflected light passing through the transparent glass, namely the first part of light L1, is substantially directed downwards. Thus, when such a lighting device is mounted at a height of approximately 2 meters above the surface of the road, the first part of light L1 is kept below the typical eye position of the cyclist, i.e. around 1.5 meter above the surface of the road, thereby avoiding direct glare.

The person skilled in the art should understand that the form of each of the reflecting surfaces 22 and 23 of the first reflector 20 can be any of a parabola, tilt parabola, flat plane, hyperbola, tilt hyperbola and other proper curves or a complex curve composed of a combination of the aforementioned curves.

Preferably, the light source 10 can be composed of, for example, one or more LEDs. The LEDs can be soldered on a PCB either individually or as a cluster.

As seen in FIGS. 1 and 2, the reflector and the sealing glass are used to direct the light from the light source 10 into the two parts of light L1 and L2. However, the person skilled in the art should understand that the reflector and/or the sealing glass can be also replaced by other optical elements to produce light having a desired luminance intensity. For example, the person skilled in the art should understand that in order to direct the light from the light source 10 to a target surface and achieve homogeneous illumination thereon, a lens can be used instead of the reflector 20.

It should also be noted that the light sources 10 in FIGS. 1 and 2 are positioned at the top and at the left, respectively, but this is just taken as an example and is not a limiting factor of the invention, and the person skilled in the art should understand that the light source 10 can be placed in any desired position to achieve desired light in conjunction with the optical elements. For example, the light source 10 can be placed at the bottom.

FIG. 4 illustrates a side view of a portion of a luminaire 3 according to an embodiment of the invention. The luminaire 3 comprises a pole 2 and three lighting devices 1 mounted into the pole in the vertical direction. It should be noted that the pole 2 is generally elongated and only a portion of the pole 2 is illustrated.

Referring to FIG. 4, it should also be noted that although the lighting device 1 of FIG. 1 is illustrated in FIG. 4, the lighting device 1 of FIG. 3 as well as the lighting device according to other embodiments of the invention can be mounted into the pole 2. Moreover, the person skilled in the art should understand that any number of lighting devices other than the three lighting devices illustrated in FIG. 4 can be mounted into the pole.

When the luminaire 3 is installed on a road comprising both a motorway part and a non-motorway part, the one or more lighting devices 1 can be configured to face the non-motorway part, as shown in FIG. 4. Preferably, the first part of light L1 depicted by means of solid line arrows is directed toward the surface of the non-motorway part, and the second part of light L2 depicted by means of dashed line arrows provides efficient lighting in the vertical space above the road surface. Since the first part of light L1 is concentrated on the target surface, i.e. the road surface, by means of the specular reflector, the light from the light source 10 is used in an efficient way. Since the second part of light L2 is diffused, bright yet soft lighting is achieved in the surroundings of the non-motor way part. Moreover, the lighting devices 1 are preferably mounted at a distance of around 2 meters above the bottom of the pole. In this way, no light will go directly to the eyes of persons on the road, and uncomfortable glare can therefore be avoided.

Additionally, in order to provide illumination for the motorway part, another lighting device such as the conventional road lamp or any desired types of lighting devices can be mounted into the pole 2 and arranged so as to face toward the motorway part.

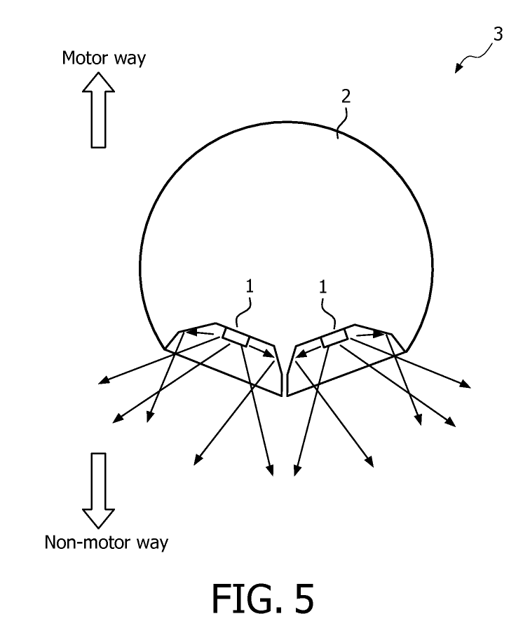

FIG. 5 illustrates a top view of a luminaire 3 according to another embodiment of the invention, wherein two lighting devices 1 are mounted into a pole 2 in the horizontal direction. It should be noted that only the first part of light L1 depicted by means of a solid line arrow is illustrated in FIG. 5 for the sake of conciseness.

Referring to FIG. 5, the lighting devices 1 are mounted such that both face the non-motorway part, but the corresponding first part of light L1 of each of the lighting devices is directed into a different direction, thus providing lighting on a different portion of the non-motorway part. In this manner, the illumination area of the luminaire 3 can be enlarged to finally achieve homogeneous illumination along the non-motorway part. People skilled in the art should understand that the number of lighting devices is not limited to two.

Although embodiments of the present invention have been described above, it will be understood by those skilled in the art that various modifications can be made without departing from the scope and spirit of the appended claims.

1. A lighting device comprising an optical nodule, the optical module comprising:
a first optical element, configured to direct light from a light source into a first part of light, and
a second optical element, configured to direct the light from the light source into a second part of light, wherein the first part of light and the second part of light are different in luminance intensity distribution.

2. The lighting device as claimed in claim 1, wherein the first optical element is configured to concentrate the first part of light, on a portion of a road surface.

3. The lighting device as claimed in claim 2, wherein the second optical element is configured to direct the second part of light toward a space above the portion of the road surface.

4. The lighting device as claimed in claim 1, wherein the second optical element is configured to diffuse the light from the light source.

5. The lighting device as claimed in claim 2, wherein the first optical element is configured such that the illumination of the first part of light on the road surface is homogeneous.

6. The lighting device as claimed in claim 1, wherein the first optical element comprises a specularly reflecting surface or a lens.

7. The lighting device as claimed in claim 3, wherein the second optical element comprises a diffusely reflecting surface or a piece of glass that is frosted.

8. The lighting device as claimed in claim 5, wherein the form of the specularly reflecting surface is a curve comprising one or more of the following:
parabola;
tilt parabola;
flat plane;
hyperbola;
tilt hyperbola.

9. The lighting device as claimed in claim 3, further comprising the light source.

10. The lighting device as claimed in claim 9, wherein the light source comprises one or more LEDs.

11. A luminaire comprising:
a pole, and
one or more lighting devices, as claimed in claim 3, mounted into the pole.

12. The luminaire as claimed in claim 11, wherein two or more lighting devices are mounted in a horizontal direction or in a vertical direction.

13. The luminaire as claimed in claim 11, wherein the one or more lighting devices are mounted at a predetermined distance above the bottom of the pole.

14. The luminaire as claimed in claim 12, wherein the two or more lighting devices are mounted so that the corresponding first part of light of at least two of the two or more lighting devices is directed in a different direction.
